(19) United States
(12) Patent Application Publication
(10) Pub. No.: US 2020/0207508 A1
(43) Pub. Date: Jul. 2, 2020

(54) CARTON WITH REMOVABLE TOP PORTION

(71) Applicant: Generale Biscuit, Clamart (FR)

(72) Inventor: Mark Kansburg, East Hanover, NJ (US)

(21) Appl. No.: 16/612,704

(22) PCT Filed: May 11, 2018
(86) PCT No.: PCT/IB2018/000653

§ 371 Date: Nov. 11, 2019

Related U.S. Application Data
(60) Provisional application No. 62/508,743, filed on May 19, 2017.

(51) Int. Cl. B65D 5/54; B65D 5/42; B65D 5/02; B31B 50/25; B31B 50/74

(52) U.S. Cl. CPC B65D 5/5445; B65D 5/4266; B31B 50/74; B65D 5/0227; B31B 50/25; B65D 5/0209

(57) ABSTRACT

A carton having a removable top portion is described herein, with the carton having a front panel, a rear panel opposite the front panel, and first and second side panels each extending between the front and rear panels. A pattern of panel lines of weakness extends about the front, rear, first side and second side panels and is configured to be ruptured to permit a top portion of the carton to be at least partially removed. The pattern includes a pair of diverging lines of weakness in each of the first side and second side panels. The diverging lines of weakness each are closer together toward a front of the carton as compared to the rear of the carton such that a greater force is required to rupture the pair of diverging lines of weaknesses in each of the first side and second side panels adjacent the rear side panel as compared to adjacent the front side panel.

### FIELD

A carton with a removable top portion is described herein, and, in particular, a carton having a pattern of lines of weakness extending about front, rear, first side and second side panels to facilitate at least partial separation of the top portion.

### BACKGROUND

Incorporating a score, perforation or cut line pattern that facilitates removal of the entire top portion of a carton can undesirably weaken the carton. These weakened areas can present issues when the carton bears a compressive load, such as when stacked during shipment or while on display in a retail environment. While score lines can be configured to improve the structural integrity by limiting the amount of weakness on the score line, limiting the weakness of the score line typically makes it more difficult to tear the carton along the score line.

### SUMMARY

A carton having a removable top portion is described herein, with the carton having a front panel, a rear panel opposite the front panel, and first and second side panels each extending between the front and rear panels. A pattern of panel lines of weakness extends about the front, rear, first side and second side panels and is configured to be ruptured to permit a top portion of the carton to be at least partially removed. The pattern includes a pair of diverging lines of weakness in each of the first side and second side panels. The diverging lines of weakness each are closer together toward a front of the carton as compared to the rear of the carton such that a greater force is required to rupture the pair of diverging lines of weaknesses in each of the first side and second side panels adjacent the rear side panel as compared to adjacent the front side panel.

The exemplary cartons described herein and depicted in the figures employ lines of weakness (e.g., score lines or partial depth or complete depth cuts) configured to facilitate at least partial removal of the top portion of the carton while also maintaining sufficient structural carton integrity. The described cartons can have a structural integrity that allows cartons to withstand a compressive load, such as when the cartons are stacked upon one another, without causing the cartons on the bottom of the stack to collapse, break, or tear in an undesired fashion. These benefits can be achieved, for example, by varying the force required to tear or rupture among different lines of weaknesses or segments of lines of weaknesses. For instance, the varying the average ratio of cut length to land length of a perforation, score pattern, or other such line of weakness (e.g., the cut/land ratio) or depth or depths of a thinned die line of weakness at various locations about the carton, strategically placing cuts and lands at certain locations based on the carton geometry, providing sections that facilitate the initial breaking or puncture of the score line, strategically angling the lines with respect to the geometry of the carton, and/or providing crease lines in the carton to weaken one or more of the panels after initial rupturing of one panel to facilitate further tearing of other panels can be used alone or in various combinations to facilitate opening of the carton.

In some aspects, the lines of weakness can be configured so that certain portions employ a stronger configuration (e.g., by employing a smaller cut/land ratio, i.e., by using larger lands, smaller cuts, or a combination thereof), whereas other portions employ an easier tearing or rupturing configuration (e.g., by employing a larger cut/land ratio, i.e., using smaller lands, larger cuts, or a combination thereof). The stronger configurations may be employed along certain portions of the carton that are likely to experience high levels of stress, tension, compression, or other force. Thus, the stronger configurations add structural integrity to the carton. The easier tearing or rupturing configurations may be employed along regions that are more difficult to tear, such as along non-straight portions of the score line.

When determining a perforation pattern, two competing objectives arise: ease of opening by a consumer and structural integrity during handling. The perforation pattern of the carton described herein balances these two competing objectives by making the perforation pattern easy to break at the beginning (thereby addressing the first objective, ease of opening), while requiring greater force to open toward the end of the pattern (thereby addressing the second objective, structural integrity). However, while there is a greater force to open toward the end of the pattern, that greater force does not feel like a greater force to a consumer during opening. First, there is some momentum gained as the tearing progresses. Second, similar to a lever action, there is a mechanical advantage gained as a user, grasping the starter portion, is tearing the diagonal perforation lines rearward and the “fulcrum” keeps shifting rearward thereby resulting in a larger “lever arm” and thus increased mechanical advantage.

As described above, the perforation pattern includes a pair of diverging lines of perforation, preferably such pair being present in both the first side panel and the second side panel. Optionally, the pair of diverging lines of weakness can be inclined, such as closer to the top adjacent the rear of the carton as compared to the front of the carton. The diverging lines of perforation are spaced closer together toward the beginning of the pattern and are spaced further away toward the end of the pattern. Having the lines spaced closer together means that the pattern is easier to tear, while the further away the lines are spaced the greater force required to tear. The series of through cuts and lands alternative between the two perforation lines, thereby resulting in a zipper type of effect where, during opening, the tearing will jump between cuts of the lines. When the two lines are closer together, it is easier for the tear pattern to jump between the two lines as compared to when the two lines are further apart. The closer the lines are together, the easier to separate, while the further apart, the more force is required to separate.

In addition to the pair of diverging lines of weakness, which are optionally inclined, the pattern can include a starter line of weakness extending around at least a portion of a periphery of a starter portion in the front panel. The starter line of weakness can be configured to require a lower force to rupture as compared to the pair of inclined, diverging lines of weakness in each of the first side and second side panels. The pair of inclined, diverging lines of weakness each can optionally continue from the first and second side panels into the front panel adjacent ends of the starter line of weakness.

In addition to the pair of diverging lines of weakness and the optional starter line of weakness, the pattern can include a rear panel line of weakness that is configured to require a lower force to rupture as compared to the pair of inclined, diverging lines of weakness in each of the first side and second side panels. The rear panel line of weakness can be linear and the starter line of weakness can be curved.

In some aspects, the front panel has a pair of crease lines, one of the crease lines extending from adjacent one end of the starter line of weakness toward the top of the carton and the other of the crease lines extending from adjacent the other end of the starter line of weakness. The crease lines are configured to facilitate flexing of the first and second side panels toward each other during removal of the top portion of the carton.

In some aspects, the pattern of panel lines of weakness is formed from a series of cuts and lands.

In some aspects, a cut of the pattern extends across an intersection of the front and first side panels, and another cut of the pattern extends across an intersection of the rear and first side panels to facilitate tearing along the pattern from the front panel to the first side and second side panels.

In some aspects, fold lines are formed between the front panel and the first and second side panels, with the fold lines including a series of spaced cuts to facilitate folding about the fold lines, and wherein a cut of the pattern extends across one of the cuts in the fold line between the front panel and the first side panel, and another cut of the pattern extends across one of the cuts in the fold line between the front panel and the second side panel. Similarly, fold lines can be formed between the rear panel and the first and second side panels, with the fold lines including a series of spaced cuts to facilitate folding about the fold lines. A cut of the pattern can intersect one of the cuts in the fold line between the rear panel and the first side panel, and another cut of the pattern can intersect one of the cuts in the fold line between the front panel and the second side panel.

In some aspects, an average length of the cuts of each of the pair of inclined, diverging lines of weakness in each of the first side and second side panels is less than an average length of the cuts of the pattern in the front and rear panels.

In some aspects, each of the pair of inclined, diverging lines of weakness can include a linear, upper line and a linear, lower line, and wherein cuts of the upper line are disposed above lands of the lower line and wherein lands of the upper line are disposed above cuts of the lower line.

A method of opening the carton described herein can include breaking the starter line of weakness and then propagating a tear along the pair of diverging lines of weakness in each of the first side and second side panels. The method can further include either partially removing the top portion (such as if the rear of the top portion remained connected to the rear panel) or completely removing the top portion.

### BRIEF DESCRIPTION OF THE DRAWINGS

FIG. 1 is a blank suitable for forming a carton having a removable top portion, and showing a pattern of panel lines of weakness extending in front, rear, first side and second side panels, and including a pair of diverging lines of weakness in each of the first and second side panels;

FIG. 2 is a front perspective view of the blank of FIG. 1 folded into a sleeve, showing parallel front and rear panels and parallel first and second side panels, along with open top and bottom panels;

FIG. 3 is a front perspective view of the sleeve of FIG. 2, showing a free end of the front panel curved and held in place by first and second top panels;

FIG. 4 is a front perspective view of the sleeve of FIG. 3, showing the first top panel folded to close a top of the carton;

FIG. 5 is a front perspective view of the sleeve of FIG. 4, showing the second top panel folded to close the top of the carton;

FIG. 6 is a front perspective view of the carton formed from the blank of FIG. 1 with the top and bottom closed;

FIG. 7 is a front perspective view of the carton with the top portion having been removed;

FIG. 8 is a diagrammatic representation of the operation of the pair of diverging lines of weakness;

FIG. 9 is an elevation view of a first side of the carton of FIG. 7, showing the pair of diverging lines of weakness in the first side panel;

FIG. 10 is an elevation of a second side of the carton of FIG. 7, showing the pair of diverging lines of weakness in the second side panel;

FIG. 11 is an elevation view of the front of the carton of FIG. 7, showing the front panel and a starter portion of the pattern of lines of weakness;

FIG. 12 is an elevation view of the rear of the carton of FIG. 7, showing the rear panel and a part of the pattern of lines of weakness;

FIG. 13 is a top plan view of the carton of FIG. 7; and

FIG. 14 is a bottom plan view of the carton of FIG. 7.

### DETAILED DESCRIPTION

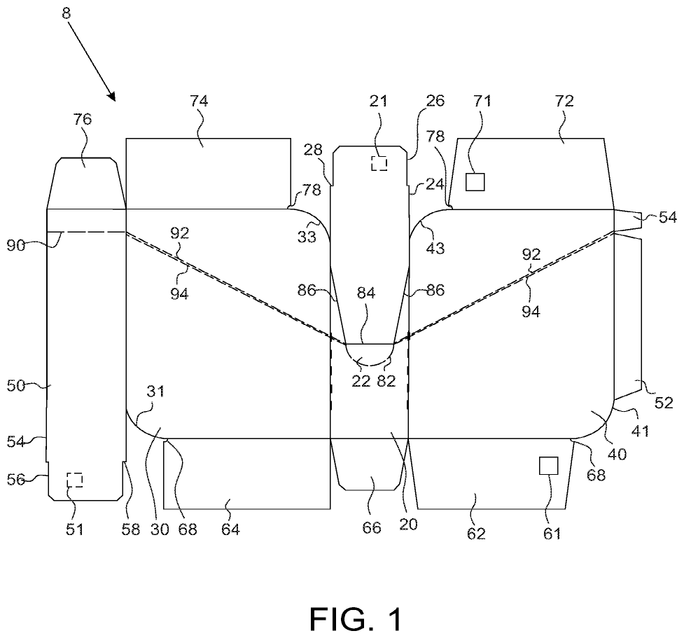

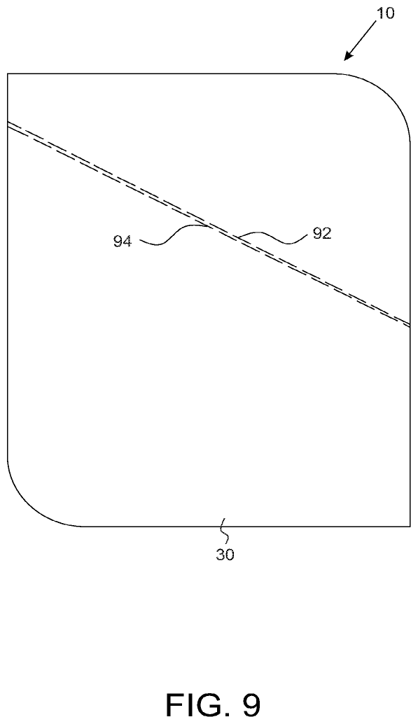

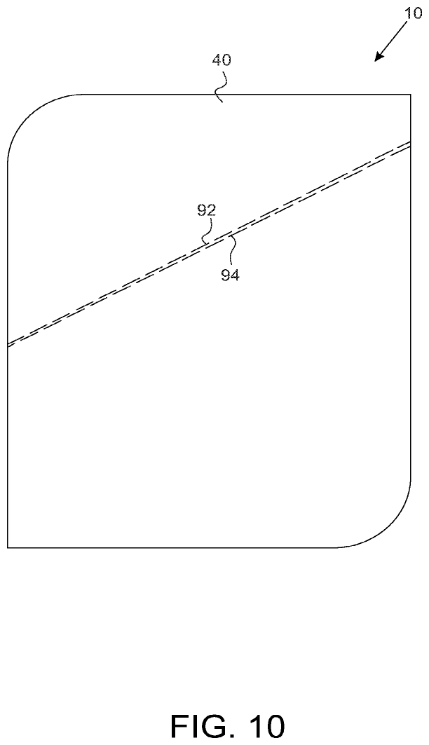

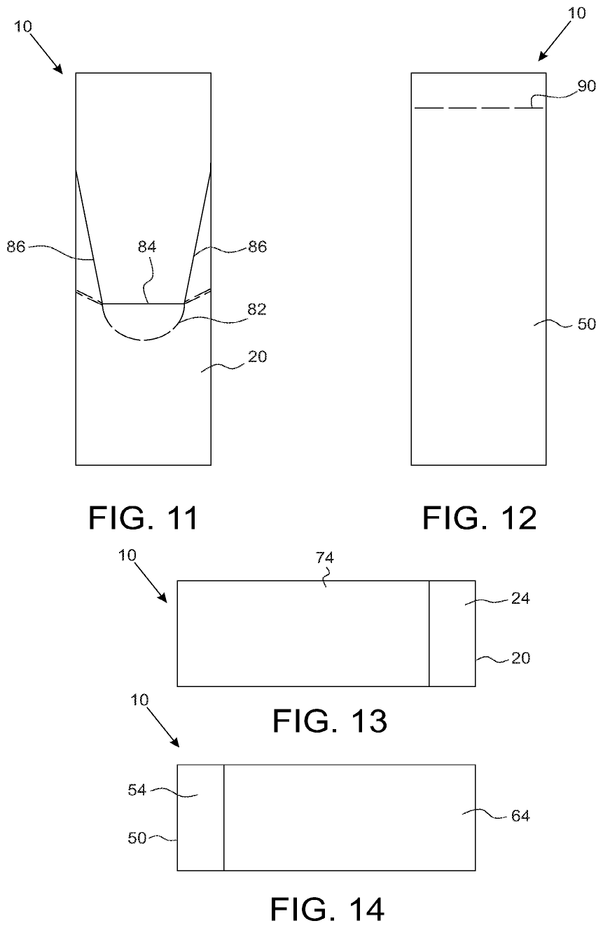

The exemplary cartons described herein and depicted in FIGS. 1-14 employ lines of weakness (e.g., perforation or cut lines) configured to facilitate at least partial removal of a top portion of the carton 10 while also maintaining sufficient structural carton integrity. A pattern of lines of weakness can be used in connection with the top-removal feature. Improved structural integrity of the carton 10, particularly in compressing loading, can be achieved by varying the average ratio of cut length to land length of a perforation, score pattern, or other such line of weakness (e.g., the cut/land ratio) at various locations about the carton 10, strategically placing cuts and lands at certain locations based on the carton geometry, providing sections that facilitate the initial breaking or puncture of the line of weakness, strategically angling one or more of the lines of weakness with respect to the geometry of the carton, and/or providing crease lines in the carton to weaken one or more of the panels after initial rupturing of one panel to facilitate further tearing of other panels.

In particular, two of the panels 30 and 40 each have a pair of diverging lines of weakness 92, 94 that are closer together toward the front of the carton 10, adjacent an opening feature or starter portion 22, as compared to toward the rear of the carton 10. As will be discussed further herein, the diverging lines of weakness 92, 94 advantageously make rupturing easier and with less force required closer to the front of the carton 10—which makes it easier for a consumer to initiate tearing along those lines of weakness 92, 94—while also advantageously making rupturing with more force required closer to the rear of the carton 10—which contributes to the structural integrity of the carton 10.

The carton 10 includes a front panel 20, rear panel 50, a first side panel 30 and a second side panel 40, as shown in FIGS. 6 and 9-14. The carton 10 also includes a pair of flaps 72, 74 which form a top of the carton 10, as well as a pair of flaps 62, 64 which form a bottom of the carton 10, as shown in the carton blank of FIG. 1. When assembled, the carton 10 includes a pair of optional curved corners and a pair of rectilinear corners, as shown in FIG. 6. Details of the construction of the carton 10, including the curved corners, will be discussed further herein.

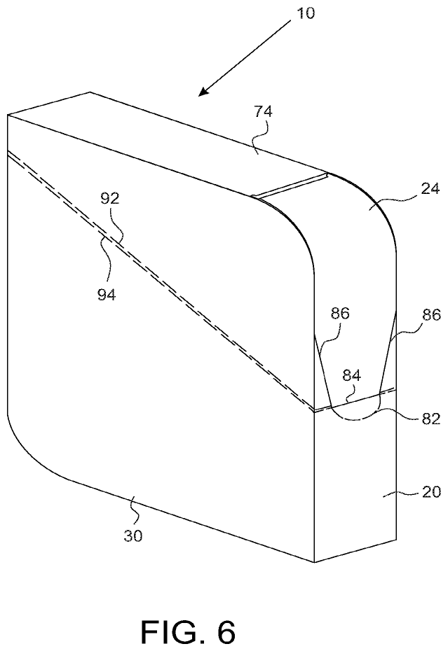

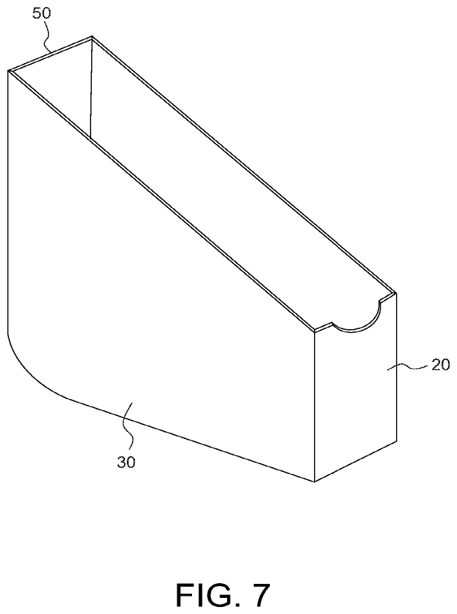

A pattern of lines of weakness, as shown in the blank of FIG. 1, extends about a periphery of the carton 10 to facilitate removal of the top portion of the carton 10. When the top portion is fully removed, as shown in FIG. 7, access is available to contents disposed within the carton 10. The pattern of lines of weakness includes a pattern 82 disposed about the starter portion 22 in the front panel 20. The pattern of lines of weakness also includes the pair of inclined, diverging lines of weakness 92, 94 disposed in each of the first side panel 30 and the second side panel 40. Those diverging lines of weakness 92, 94 also continue in the front panel 20 toward the pattern 82 disposed about the starter portion 22. Finally, the rear panel 50 includes a linear rear line of weakness 90.

Preferably, though not necessarily, the pattern of lines of weakness are formed from a series of cuts spaced by lands. The cuts are preferably, though not necessarily, through cuts extending completely through the thickness of the carton material. The pattern 82 disposed about the starter portion 22 and the rear line of weakness 90 include a series of long cuts spaced by short lands. This makes those lines of weakness 82, 90 relatively easier to tear, i.e., relatively less force is required to rupture the carton 10 along those lines of weakness 82, 90. While this can structurally weaken the carton 10, it also makes those lines of weakness 82, 90 easier to tear. Further, providing such lines of weakness 82, 90 in the front and rear panels 20, 50, respectively, which are significantly narrower than the first side panel 30 and second side panel 40 in the illustrated embodiment, reduces the impact to the structural integrity of the carton 10. Conversely, the diverging lines of weakness 92, 94 are each formed of linear lines of cuts that are much shorter in length than the line of weakness 82 about the starter portion 22 and the rear panel line of weakness 90. Combined with the length of the lands, this means that rupturing along one of the diverging lines of weakness 92, 94 requires a greater force as compared to along the line of weakness 82 about the starter portion 22 and the rear panel line of weakness 90.

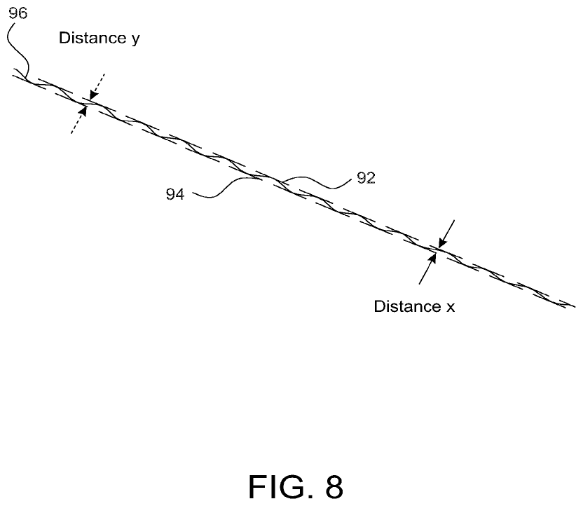

As mentioned above, the first side panel 30 and the second side panel 40 each include a pair of inclined, diverging lines of weakness 92, 94. Specifically, each of the side panels 30, 40 includes an upper line of weakness 92 and a lower line of weakness 94. Preferably, though not necessarily, the cut of the lower line of weakness 94 is disposed below a land of the upper line of weakness 92, and the cut of the upper line of weakness 92 is disposed above a land of the lower line of weakness 94. By having a pair of lines of weakness 92, 94 with such a cut and land arrangement, the tear pattern 96 tends to alternate between the upper and lower lines of weakness 92, 94, shown diagrammatically in FIG. 8. In other words, the tear pattern 96 moves back and forth between the cuts of the upper line of weakness 92 and the lower line of weakness 94, with the back and forth generally occurring when a land is reached. If the lines 92, 94 were parallel, then there would be a more constant force during opening. However, by having the lines 92, 94 diverging, the opening force is not constant. More specifically, less opening force is required adjacent the front of the carton 10 where the lines 92, 94 are closer together. That is because there is less distance (distance x in FIG. 8) between the upper and lower lines of weakness 92, 94, making the back and forth tear between the two lines 92, 94 easier. As the lines 92, 94 diverge toward the rear of the carton 10, the distance between the lines increases. This means that a greater opening force is required, because there is a greater distance (distance y in FIG. 8) between the upper and lower lines of weakness 92, 94 that is torn during making the back and forth tear. Although the tear can propagate in a back and forth manner, such a back and forth manner may not be precise, such as if one or more lands were ruptured in a given line 92, 94 instead of tearing to the adjacent line 92, 94. By having different opening forces along the diverging lines of weakness 92, 94, the overall structural integrity of the carton 10 can be improved as compared to if there were parallel lines of weakness configured for ease of rupturing. Even though the force required to rupture the diverging lines of weakness 92, 94 adjacent the rear of the carton 10 is greater as compared to the front of the carton 10, a user opening the carton 10 may not notice or experience the full extent of the force differential. That is because as the tearing progresses, there is a momentum of the tear force that builds, which momentum force can at least partially offset the greater force required toward the rear of the carton 10. In addition, a lever-type action as the top portion is torn off can at least partially offset the greater force required toward the rear of the carton 10.

Another advantage to the diverging lines of weakness 92, 94 is that by creating the two alternating lines of weakness 92, 94 with alternating cuts and lands, when pressure is applied to the side of the carton 10 the lines of weakness 92, 94 are more able to bend and deflect instead of breaking. The taper increases the width of this portion that deflects and adds to the strength and ability to deflect. This can also benefit from having the spacing between cuts left larger to reduce risk of tearing between cuts when this type of force is applied.

While the lengths of the cuts and lands for the diverging lines of weakness 92, 94 are shown as being constant, they could also vary, and, indeed, can vary in a manner that further makes the opening force less adjacent the front as compared to the rear of the carton 10. For example, the cuts could be larger toward the front of the carton 10 and/or the lands shorter as compared to toward the rear of the carton 10.

Turning to details regarding the starter portion 22 and the front panel 20, the starter portion 22 can be sized for depression into the carton 10 with a thumb or other finger. Depending on the size, shape, and configuration of the carton 10, the starter portion 22 can also vary in size and shape. In one example embodiment, the starter portion 22 can be a semicircle centered on the front panel 20 but spaced from side edges thereof. The starter portion 22 can be configured to break and fold inward along a crease line 84 when pressed by a user. This breaking can serve to initiate the breaking of one or more lines of weakness 92, 94 of the pattern in order to completely remove or partially remove the top portion of the carton.

The front panel 20 can optional include two crease lines 86 which extend generally upward from the starter portion 22 toward the top of the carton 10. The creases lines 86 allow the front panel 20 to bend, bow, and/or flex after the starter portion 22 has been separated by the line of weakness 82 disposed adjacent thereto. For example, upon breaking of the starter portion 22, a user can pull on the top portion of the carton 10 in an upward and/or outward direction using, a finger or thumb, thereby causing the front panel 20 to bend or flex in the direction of the pull. This bending or flexing allows the top portion of the carton to direct stress vectors along the pattern of lines of weakness. Directing stress vectors along the pattern, and generally along a plane that is close to parallel with the pattern, can help propagate the tearing without branching off in an undesired direction.

In operation, a user wishing to remove the top portion of an assembled carton 10 will start by bending the starter portion inwards with a finger or thumb by breaking starter score line of weakness 82 extending around part of the periphery of the starter portion 22. After breaking the starter portion 22, the user's thumb or finger can then pull outward and upward on the front panel 20, whereby the optional crease lines 86 on the front panel 20 can allow front panel 20 to bend, bow, or otherwise flex outward. This outward flexing can help the user's pulling force vectors run along a plane that is generally more parallel with the plane of pattern. Thus, the pull force vector can cause the diverging lines of weakness 92, 94 present in the front panel to break, thereby allowing the tear to propagate along pattern up to corners between the front panel 20 and the first side panel 30 and second side panel 40. The user can continue to provide an outward and upward force at an angle that is generally sufficient to generate a force vector that runs relatively parallel to the plane of pattern. The pull force vector can cause the tear to propagate along the lines of weakness 92, 94 on the first and second side panels 30, 40. Accordingly, top portion can be bent backward from the carton 10. The top portion can thereafter be removed from the carton 10 by breaking rear panel line of weakness 90. Additionally and/or alternatively, a user may elect to keep the top portion attached to the carton 10 so as to subsequently re-cover the carton 10 at a later time.

The pattern preferably, though not necessarily, includes one or more cuts that extend across corners of the carton. These cuts extending around the corners help propagate the tearing along the pattern around the corners between the front panel 20 and the first and second side panels 30, 40, and between the first and second side panels 30, 40 and the rear panel 50.

The carton material may optionally be of such a thickness that scores, cuts or perforations are present in folds between the various panels to facilitate folding. If present, the cuts of the pattern of the lines of weakness preferably either cross or intersect the scores, cuts or perforations in folds of between the various panels.

Turning now to details of the construction of the carton, as mentioned above the carton 10 can optionally include one or a pair of curved corners, as shown in FIG. 6. If two corner are present, they can be on the same side or, as shown, diagonally opposed. The front panel 20 and the rear panel 30 each include an extension 24, 54, unattached to the either the first or second side panel 30, 40, that can be curved during assembly. Each of those extensions 24, 54 include a narrowed end portion 26, 56 with indentations 28, 58 formed on each side at the junction with the remainder of the extension 24, 54, as shown in FIG. 1. The pair of flaps 72, 74 that form the top of the carton 10 each include an indentation 78, as shown in FIG. 1, for engaging the indentations 28,58 of the extensions 24, 54 of the front and rear panels 20, 50 during assembly.

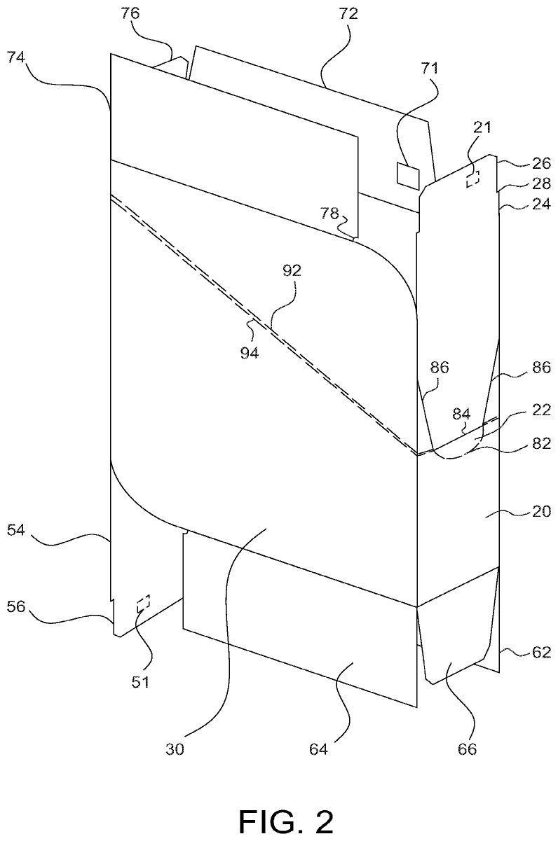

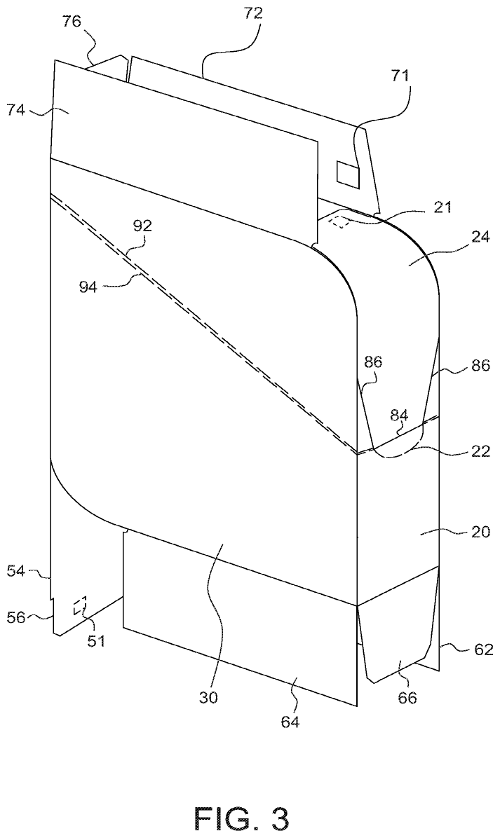

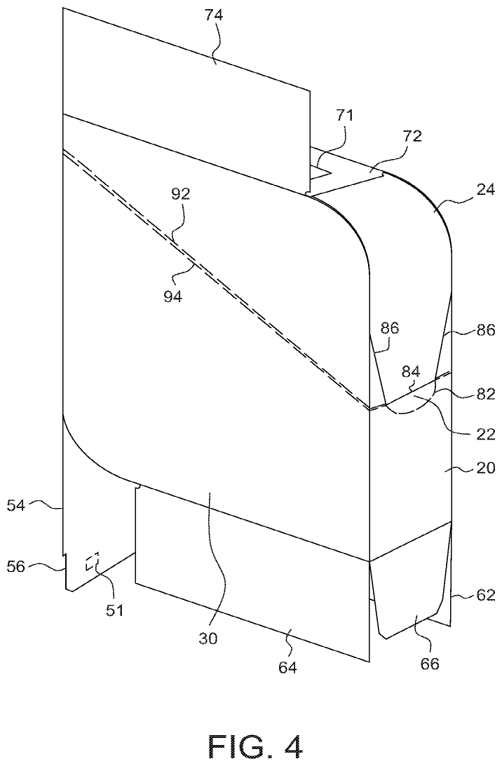

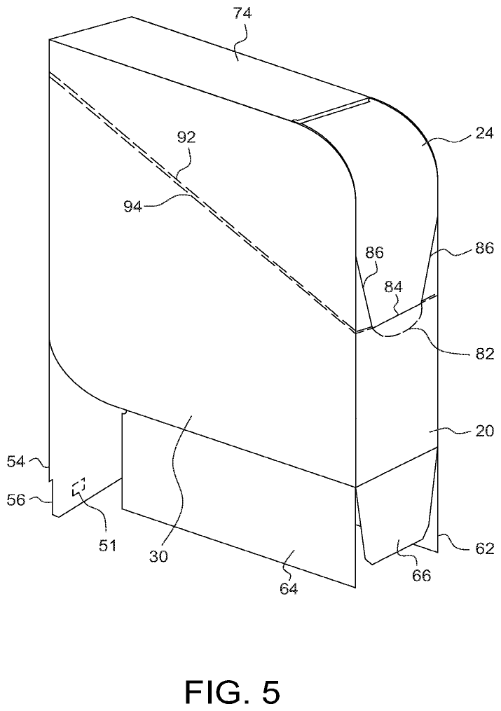

To assembly the carton 10, the carton 10 is first formed into a generally rectilinear sleeve, as shown in FIG. 2, by adhering a minor flap 52 of the second side panel 40 to the interior of the rear panel 50. A smaller minor flap 53 of the second side panel 40 can also be adhered to the interior of the rear panel 50. The smaller minor flap 53 is disposed on one side of the pair of lines of weakness 92, 94, and the minor flap 52 is disposed on an opposite side thereof, such that the smaller minor flap 53 is part of the removable top portion of the carton 10. The extension 24 of the front panel 20 can then be moved into its curved configuration and held into place by engagement of the indentations 28 of the extension and the indentations 78 of the top flaps 72, 74, as shown in FIG. 3. A first of the top flaps 72 can then be folded over the narrowed end portion 26 of the extension 24 of the front panel 20, as shown in FIG. 4. A minor flap 76 of the rear panel 50 is also folded inward. That first top flap 72 includes a window 71 which overlies the narrowed end portion 26 of the extension 24 and which is aligned with an optional embossed portion 21 of the narrowed end portion 26 of the extension 24 of the front panel 20. The second of the top flaps 74 can then be folded to overlie the first top flap 72, as shown in FIG. 5. Adhesive can extend between the underside of the second top flap 74 and the narrowed end portion 26 of the extension 24 of the front panel 20, via the window 71 in the first top flap 72, to secure the panels together. The embossed portion 21 can help to decrease the distance the adhesive extends. Optionally, the extensions 24, 54 can have a width that is greater than the distance between the first and second side panels 30, 40 of the assembled carton 10 such that the curved portion of the extensions 24, 54 abut peripheral edges of curved corners 33, 43 and 31, 41 of the first and second side panels 30, 40. The same assembly process can be repeated for the bottom of the carton 10 after filing of the carton 10 with product, such as food items, including individually wrapped food items. The bottom of the carton 10 is formed with a pair of bottom flaps 62, 64, one of which has a window 61, as well as a minor flap 66. The pair of bottom flaps 62, 64 also have indentations 68 similar to those 78 of the top flaps 72, 74 for engaging with indentations 58 of the extension 54 of the rear panel 50. An embossing 51 can also be provided in the extension 54 of the rear panel 50 for the same purpose as described above with respect to the embossing 21 in the front panel 20.

The term “line of weakness” as used herein is not limited to the specific examples described and illustrated, as a line of weakness can take different forms. For example, a line of weakness can be formed from a perforation pattern (such as with through cuts spaced by lands), a score pattern (such as with partial depth cuts optionally spaced by lands), thinned die lines, and the like that provide a weakened line as compared to the portions of the material immediately adjacent the weakened line, and the line does not have to be a linear line or continuous line. Moreover, the weakening does not have to be only on one side or the other, e.g., the inner facing side or outer facing side of a panel. The weakening can include, for example, half or otherwise partial depth cuts on either the inner facing side, the outer facing said and/or a combination thereof, such as if a line of weakness were formed of a perforation pattern with the cuts being a partial depth cut alternating between the inner and outer facing sides.

The drawings and the foregoing descriptions are not intended to represent the only forms of the carton in regard to the details of construction. Changes in form and in proportion of parts, as well as the substitution of equivalents, are contemplated as circumstances may suggest or render expedient.

1: A carton having a removable top portion, the carton comprising:
a front panel, a rear panel opposite the front panel, and first and second side panels each extending between the front and rear panels;
a pattern of panel lines of weakness extending about the front, rear, first side and second side panels, the pattern being configured to be ruptured to permit a top portion of the carton to be at least partially removed, the pattern including a pair of diverging lines of weakness in each of the first side and second side panels, the pair of diverging lines of weakness each being closer to a top of the carton adjacent the rear side panel and spaced further apart as compared to adjacent the front side panel such that a greater force is required to rupture the pair of diverging lines of weaknesses in each of the first side and second side panels adjacent the rear side panel as compared to adjacent the front side panel.

2: The carton of claim 1, wherein the pattern includes a starter line of weakness extending around at least a portion of a periphery of a starter portion in the front panel.

3: The carton of claim 2, wherein the starter line of weakness is configured to require a lower force to rupture as compared to the pair of diverging lines of weakness in each of the first side and second side panels.

4: The carton of claim 2, wherein the pair of diverging lines of weakness each continue from the first and second side panels into the front panel adjacent ends of the starter line of weakness.

5: The carton of claim 2, wherein the pattern includes a rear panel line of weakness that is configured to require a lower force to rupture as compared to the pair of diverging lines of weakness in each of the first side and second side panels.

6: The carton of claim 5, wherein the rear panel line of weakness is linear and the starter line of weakness is curved.

7: The carton of claim 2, wherein the front panel has a pair of crease lines, one of the crease lines extending from adjacent one end of the starter line of weakness toward the top of the carton and the other of the crease lines extending from adjacent the other end of the starter line of weakness, the crease lines configured to facilitate flexing of the first and second side panels toward each other during removal of the top portion of the carton.

8: The carton of claim 2, wherein the pattern of panel lines of weakness is formed from a series of cuts and lands.

9: The carton of claim 8, wherein a cut of the pattern extends across an intersection of the front and first side panels, and another cut of the pattern extends across an intersection of the rear and first side panels to facilitate tearing along the pattern from the front panel to the first side and second side panels.

10: The carton of claim 11, wherein fold lines are formed between the front panel and the first and second side panels, and wherein the fold lines include a series of spaced cuts to facilitate folding about the fold lines, and wherein a cut of the pattern extends across one of the cuts in the fold line between the front panel and the first side panel, and another cut of the pattern extends across one of the cuts in the fold line between the front panel and the second side panel.

11: The carton of claim 10, wherein fold lines are formed between the rear panel and the first and second side panels, and wherein the fold lines include a series of spaced cuts to facilitate folding about the fold lines, and wherein a cut of the pattern intersects one of the cuts in the fold line between the rear panel and the first side panel, and another cut of the pattern intersects one of the cuts in the fold line between the front panel and the second side panel.

12: The carton of claim 8, wherein an average length of the cuts of each of the pair of diverging lines of weakness in each of the first side and second side panels is less than an average length of the cuts of the pattern in the front and rear panels.

13: The carton of claim 8, wherein each of the pair of diverging lines of weakness includes a linear, upper line and a linear, lower line, and wherein cuts of the upper line are disposed above lands of the lower line and wherein lands of the upper line are disposed above cuts of the lower line.

14: A method of opening the carton of claim 2, the method comprising opening the carton by breaking the starter line of weakness and then propagating a tear along the pair of diverging lines of weakness in each of the first side and second side panels.

15: The method of claim 14, further comprising completely removing the top portion of the carton.
